(19) United States
(12) Patent Application Publication
(10) Pub. No.: US 2017/0091703 A1
(43) Pub. Date: Mar. 30, 2017

(54) TRACKING MERCHANDISE USING WATERMARKED BAGS

(71) Applicant: Datalogic ADC, Inc., Eugene, OR (US)

(72) Inventor: BRYAN OLMSTEAD, EUGENE, OR (US)

(21) Appl. No.: 15/274,212

(22) Filed: Sep. 23, 2016

Related U.S. Application Data
(60) Provisional application No. 62/232,991, filed on Sep. 25, 2015.

(51) Int. Cl. G06Q 10/08; G06K 7/14; G06K 17/00

(52) U.S. Cl. CPC G06Q 10/087; G06K 17/0022; G06K 7/1413

(57) ABSTRACT

Methods and systems are provided for tracking unpackaged merchandise for purchase in a retail environment. Merchandise is placed into bags having unique watermarks. Selected merchandise is associated with a particular bag after being identified by a merchandise identification device. Watermark scanners are used to identify the bags. The system allows for more efficient and accurate tracking of merchandise, such as produce, in a retail environment, such as a grocery store.

### CROSS-REFERENCE TO RELATED APPLICATIONS

This application claims the benefit of U.S. Application No. 62/232,991, filed Sep. 25, 2015, herein incorporated by reference.

### TECHNICAL FIELD

The present invention relates to systems and methods of tracking unpackaged merchandise in a retail environment.

### BACKGROUND

In modern retail environments for the sale of groceries, most products are available in pre-packaged form, making it easy to identify each item and charge an appropriate price based on a barcode. However, for unpackaged merchandise, such as produce, there are typically additional steps that are necessary to ensure that the proper items are identified and that the customer is paying an appropriate price.

There are four general methods by which produce and other unpackaged goods are tracked in a retail environment. The first is by individual barcoded stickers placed on each item and read with a checkout scanner. The second is by weighing and identifying produce in the produce section, printing and placing a barcode label on a bag containing the produce, and reading the barcode with a checkout scanner. A third method is manual entry of the identity of the produce at checkout. Finally, a fourth method utilizes a visual scanning system to identify the produce or narrow the choices at checkout.

These current methods of tracking unpackaged merchandise are problematic in that they are error prone and/or cumbersome. A more convenient and secure means for tracking unpackaged merchandise in a retail environment is needed.

### BRIEF SUMMARY

The technical problem underlying the present invention is to provide a method of tracking unpackaged merchandise, such as produce, from the retail environment to a point of sale in a way that is less cumbersome and less error-prone.

The Applicant has found that by utilizing bags marked with watermarks in combination with a merchandise identification device, such as a camera employing machine vision, merchandise can be tracked without examining each individual piece of merchandise at the point of sale. By identifying the individual piece of merchandise being placed into a watermarked bag, errors are reduced and the process is made more efficient at the time of check out for both the customer and the checkout clerk.

Multiple different types of merchandise can be placed in a single watermarked bag. The merchandise identification device tracks which pieces of merchandise are placed in a bag and the bag is scanned to associate the merchandise with that particular bag. Then, at checkout, the bag is quickly scanned and the contents of the bag are quickly identified. This eliminates the need for individual barcodes to be placed on each unit of merchandise or for a checkout clerk to spend time trying to identify different types of produce and entering a code for each type. The process of selecting merchandise for purchase, tracking the merchandise, and purchasing the merchandise is streamlined, reducing the risk of error and the overall amount of time required for each transaction.

Ultimately, the present invention relates to a system for tracking bagged merchandise for purchase having the features recited in claim 1. In particular, the system of the invention comprises a merchandise selection station and a point of sale station in communication with one another through a server. The merchandise selection station includes units of unpackaged merchandise in a retail environment. Bags are available to hold the units of unpackaged merchandise. Each bag is printed with a unique watermark. A merchandise identification device surveys the retail area and identifies the units of unpackaged merchandise. A first watermark scanner identifies the bags. A first computer associates each of the bags with the units of unpackaged merchandise held inside. The point of sale station utilizes a second watermark scanner to identify each of the bags. Finally, a second computer identifies the units of unpackaged merchandise associated with each scanned bag.

The invention may also include a computerized method for tracking produce for sale having the features recited in claim 9. The method begins by identifying pieces of produce selected by a user at a produce storage area by a merchandise identification device. A watermarked bag is identified with a first watermark scanner located near the produce storage area. The pieces of produce selected by the user are associated with the watermarked bag that has been scanned and the pieces of produce are associated with the bag. A second watermark scanner located at the point of sale receives information identifying the watermarked bag. Information is retrieved that associates the watermarked bag with the pieces of produce. This information is utilized to calculate a sale price for the pieces of produce.

In another exemplary system for tracking produce in a retail environment, the system includes the features recited in claim 17. The system includes bags printed with unique watermarked codes, a machine vision tracking camera for identifying units of produce being placed into the bags, and a first watermark scanner located proximate to the machine vision tracking camera and the bags for scanning and identifying the unique watermarked codes of the bags containing the units of produce. A first computing device receives produce identifying information from the machine vision tracking camera, receives bag identifying information from the first watermark scanner, and associates the produce identifying information with the bag identifying information based on the units of produce placed into the bags. A second watermark scanner located proximate to the point of sale scans and identifies the unique watermarked codes of the bags containing the units of produce. A second computing device receives the bag identifying information from the second watermark scanner, receives identifying information from the first computing device, and submits the produce identifying information associated with the bag identifying information to a point of sale device. The point of sale device then calculates an amount due.

Another computerized method of tracking unpackaged merchandise in accordance with the invention includes the steps recited in claim 21. A server receives merchandise identifying information from merchandise identification devices monitoring a merchandise selection area. The server then receives bag identifying information from a first watermark scanner in the merchandise area. The merchandise identifying information is associated with the bag identifying information at the server. Bag identifying information is then received from a second watermark scanner at a checkout area. This bag identifying information is the same as the identifying information received from the first watermark scanner. Finally, the merchandise identifying information associated with the bag identifying information is sent to a point of sale machine at the checkout area.

### BRIEF DESCRIPTION OF THE DRAWINGS

More features and benefits of the device of the present invention will become more evident from the following detailed descriptions of the preferred embodiments thereof, by way of illustrative and non-limiting examples with reference to the attached drawings. In said drawings:

FIG. 1 is a perspective view of a customer at a merchandise selection station according to the present invention;

FIG. 2 is a perspective view of a customer at a point of sale station according to the present invention;

FIG. 3 is a schematic view of an exemplary system for tracking bagged merchandise, according to the present invention;

FIG. 4 is a perspective view of an exemplary retail environment including unpackaged merchandise, a watermark scanner, and a merchandise identification device connected to a server, according to the present invention; and

FIG. 5 is a perspective view of a point of sale environment including bagged merchandise, a watermark scanner, and a point of sale, according to the present invention.

### DETAILED DESCRIPTION

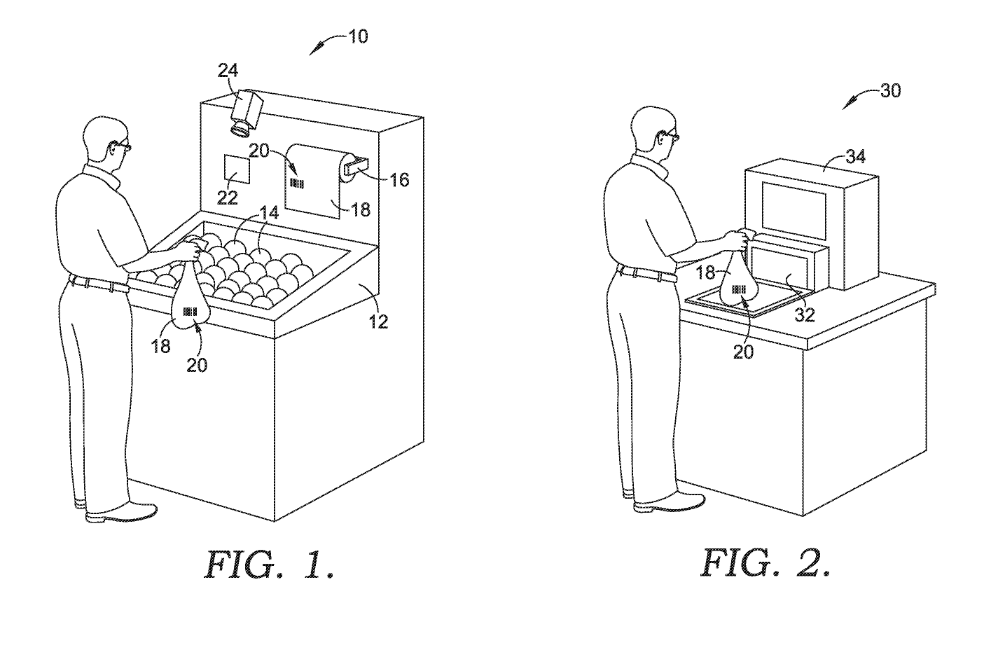

Turning to FIG. 1, an exemplary merchandise selection station 10 is shown. A merchandise display area 12 holds one or more units of unpackaged merchandise 14. The merchandise display area may be a shelf, a counter, a rack, a bin, a crate, and the like. The unpackaged merchandise may be produce such as oranges, apples, pears, and the like. Alternatively, the unpackaged merchandise may be vegetables, nuts, dried fruit, oats, or other unpackaged, unlabeled merchandise.

The merchandise display area 12 may include a bag storage apparatus 16 which holds one or more bags 18. The bags 18 are preferably made of clear plastic so that the contents of the bag are visible. The bags may alternatively be made of paper, opaque plastic, or other similar material. Each bag includes a watermark 20. The watermark 20 is a marking that is capable of being read by a watermark scanner. A watermark is an identifying image or pattern comprised of various shades of lightness and darkness when viewed with transmitted light. Each bag has its own unique watermark code such that each individual bag may be identified by the unique identifying code. For example, the unique watermark code may be a barcode. Other configurations of markings are possible. A first watermark scanner 22 scans the watermarks 20 on the bags 18 to identify each individual bag.

A merchandise identification device 24 identifies units of unpackaged merchandise 14 that are placed into the bags 18 by a customer. The merchandise identification device 24 may be a camera system, a produce identification scanner, a barcode scanner, or the like. A camera system may utilize machine vision to automatically identify the unpackaged merchandise 14. Machine vision may use two-dimensional (2-D) cameras, three-dimensional (3-D) cameras, infrared cameras, x-ray detection, and the like to acquire an image of the merchandise. Machine vision uses image capture and analysis to perform automated tasks such as inspection and counting. A combination of a video camera, analog-to-digital conversion, and digital signal processing may be employed to send data to a computing device, such as a server. A produce identification scanner identifies produce by appearance. The merchandise identification device may be a barcode scanner, but each unit of unpackaged merchandise must then include a barcode.

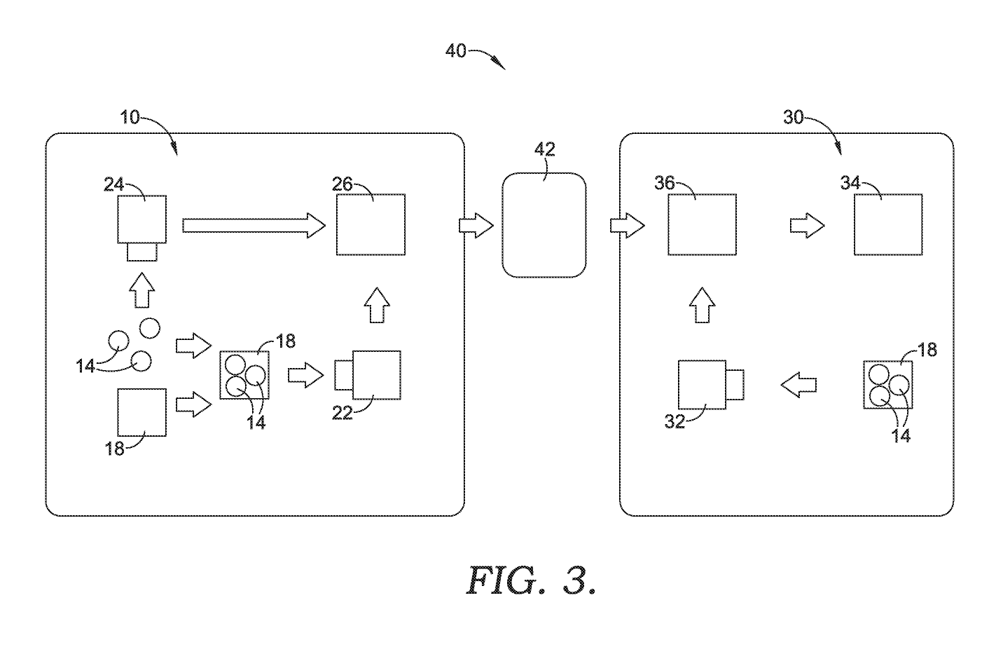

The merchandise identification device 24 and the watermark scanner 22 communicate with a server (not shown) to identify units of unpackaged merchandise that are placed into each scanned, watermarked bag 18 by a customer. This process is shown in the diagram 40 of FIG. 3. One or more units of unpackaged merchandise 14 are placed into a bag 18. The bag 18 is scanned by the first watermark scanner 22 to identify the unique watermark 20 (not shown) on the bag 18. The merchandise identification device 24 identifies the one or more units of unpackaged merchandise 14 that have been selected and placed into the bag 18. This identifying information describes a number and types of unpackaged merchandise 14 selected by the customer. There may be multiple types of unpackaged merchandise 14 held within the same bag. The unpackaged merchandise 14 may comprise unpackaged merchandise of a first type, unpackaged merchandise of a second type, or both. For instance, one bag may hold one orange, one apple, and one pear. The merchandise identification device 24 sends the identifying information for the units of unpackaged merchandise 14 to a first computer 26. The first watermark scanner 22 sends the identifying information for the watermarked bag 18 to the first computer 26. The first computer 26 associates the units of unpackaged merchandise 14 with the watermarked bag 18, creating a data record 42.

Returning to FIG. 2, an exemplary point of sale station 30 is illustrated. A second watermark scanner 32 is located at the point of sale station 30. The second watermark scanner 32 scans and identifies the bag 18 by its watermark 20. The point of sale station 30 also includes a point of sale device 34, such as a computerized cash register. When a customer or cashier scans a bag 18, the unique watermark 20 on the bag 18 is identified. The second watermark scanner 32 communicates with a server (not shown) to identify the units of unpackaged merchandise 14 that are contained within the bag 18. Using the above example, once the bag is scanned, the computer identifies the contents of the bag as being one orange, one apple, and one pear. This information is sent to the point of sale device 34 in order to determine the price that a customer is to pay for the unpackaged merchandise 14. The customer would then be charged the price of one orange, one apple, and one pear in this example.

This process is illustrated in the diagram 40 of FIG. 3. The one or more units of unpackaged merchandise 14 in a bag 18 are scanned by the second watermark scanner 32. This information is communicated to a second computer 36. The second computer 36 receives the data record 42 from the first computer 26, which associates information about units of merchandise 14 with a particular bag's 18 identifying information. The second computer 36 receives the scanned watermark information from the second watermark scanner 32 and determines which units of unpackaged merchandise 14 are associated with the scanned bag 18. This information is communicated to the point of sale device 34 where it is used to calculate an amount due.

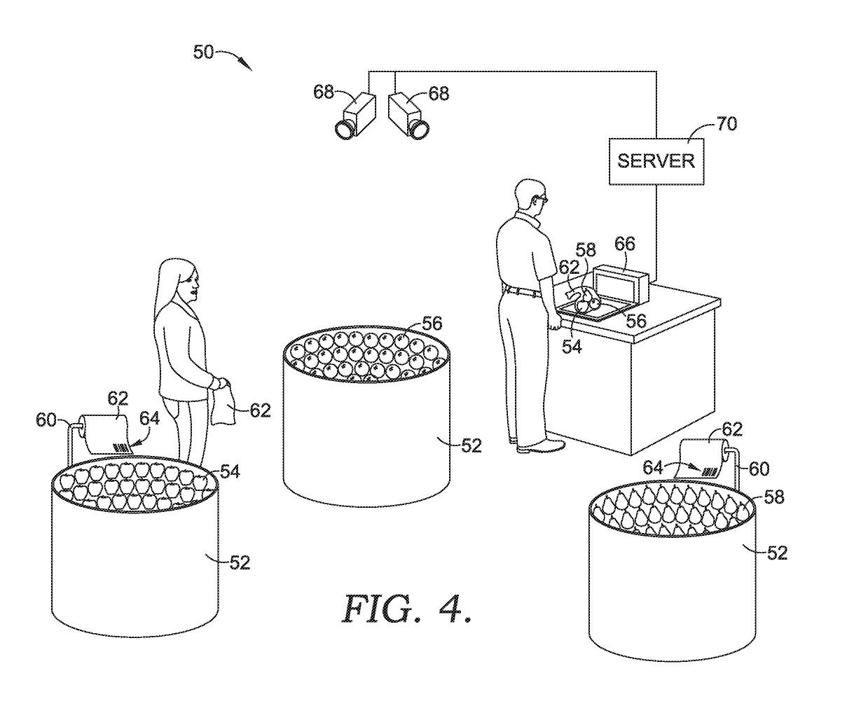

An alternative embodiment of the claimed invention is shown in FIG. 4. An exemplary retail environment 50 is depicted having multiple produce bins 52. Each produce bin 52 may contain a different type of produce. For example, one produce bin 52 may contain produce of a first type, such as apples while another produce bin 52 contains produce of a second type 52, like oranges, and a third produce bin 52 may contain produce of a third type, such as pears. Bag holders 60 may be placed at various locations throughout the retail environment 50, such as at particular produce bins 52. The bag holders 60 hold a plurality of bags 62 having watermarks 64 printed thereon. The bags 62 may be made of plastic and are stored in rolls on the bag holders 60. Before selecting pieces of produce to purchase, a customer obtains a bag 62 from a bag holder 60. The customer may then place one or more pieces of produce 54, 56, 58 into the bag 62.

The one of more pieces of produce may comprise at least two pieces of produce, wherein the two pieces of produce are of different types. For example, a customer may place one piece of produce of a first type 54, one piece of produce of a second type 56, and one piece of produce of a third type 58 into a single bag 62. For example, a customer may choose one apple, one orange, and one pear to put into a bag 62.

One or more machine vision tracking cameras 68 monitor the retail environment 50. The machine vision tracking cameras 68 detect which pieces of produce are being selected and placed into a bag 62 by a customer. In the example of FIG. 4, the machine vision tracking cameras 68 recognize that the man has placed an apple 54, an orange 56, and a pear 58 into a bag 62. In alternate examples, two bananas, a bell pepper, and three carrots could be put into the bag and the machine vision tracking cameras would recognize the type and quantity of all of the items in the bag. This identifying information is sent to a server 70.

Once the customer has filled one or more bags 62 with produce, the customer scans the bag(s) 62 at a first watermark scanner 66. The identifying information for the watermark 64 on the bag 62 is sent from the first watermark scanner 66 to the server 70. The server 70 associates the produce identifying information received from the machine vision tracking cameras 68 with the bag identifying information from the watermark scanner 66.

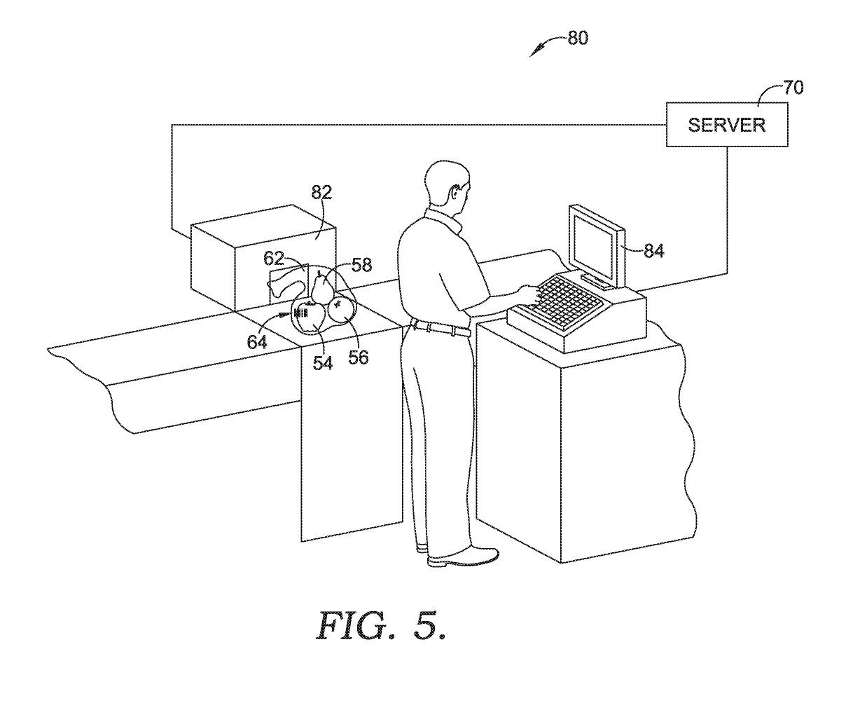

FIG. 5 illustrates an exemplary point of sale area 80 in accordance with an embodiment of the invention. Here, the bag 62 from FIG. 4 containing an apple 54, an orange 56, and a pear 58 is being scanned at a second watermark scanner 82. The second watermark scanner 82 reads the watermark 64 on the bag 62 to identify the bag 62. This information is sent to the server 70. The server 70 receives the identifying information for the bag 62 and retrieves the associated information identifying the contents of the bag 62, which includes the three types of produce 54, 56, 58. The identifying information specifies a quantity and types of produce contained in the watermarked bag. The information identifying the produce is submitted to a point of sale device 84 at the point of sale area 80. The point of sale device 84 may be operated by a cashier or may be operated by a customer in a self-service fashion. The point of sale device 84 utilizes the information identifying the contents of the bag 62 to calculate an amount that a customer must pay for the produce.

Naturally, a person skilled in the art could make additional changes and variations to the invention described above in order to satisfy specific and contingent application requirements, variations and modifications that nonetheless fall within the scope of protection as defined by the subsequent claims.

What is claimed is:

1. A system for tracking bagged merchandise for purchase, comprising:
a merchandise selection station comprising:
one or more units of unpackaged merchandise;
one or more bags for holding the one or more units of unpackaged merchandise, each of the one or more bags comprising a unique watermark printed thereon;
a merchandise identification device for identifying the one or more units of unpackaged merchandise;
a first watermark scanner for identifying the one or more bags; and
a first computer, having a memory coupled to one or more processors, for associating each of the one or more bags with the one or more units of unpackaged merchandise held inside; and
a point of sale station comprising:
a second watermark scanner for identifying each of the one or more bags;
wherein the point of sale station is in communication with the merchandise selection station via a network having a server.

2. The system of claim 1, further comprising:
a second computer, having a memory coupled to one or more processors, for identifying the one or more units of unpackaged merchandise associated with one of the one or more bags; and
a point of sale device for receiving the identifying information from the second computer to determine an amount due for the one or more units of unpackaged merchandise held inside the one of the one or more bags.

3. The system of claim 1, wherein the unique watermark is a barcode.

4. The system of claim 1, wherein the merchandise identification device is a camera.

5. The system of claim 4, wherein the camera utilizes machine vision techniques to identify the one or more units of unpackaged merchandise.

6. The system of claim 1, wherein the merchandise identification device is a produce identification scanner.

7. The system of claim 1, wherein the merchandise identification device is a barcode scanner and wherein the one or more units of unpackaged merchandise comprise barcode labels.

8. The system of claim 1, wherein the one or more units of unpackaged merchandise comprise at least one unit of unpackaged merchandise of a first type and one unit of unpackaged merchandise of a second type.

9. A computerized method of tracking produce for sale, comprising:
identifying, using a merchandise identification device, one or more pieces of produce selected by a user in a retail environment;
identifying a watermarked bag with a first watermark scanner located in the retail environment;
associating the one or more pieces of produce with the watermarked bag;
receiving information from a second watermark scanner located at a point of sale, the information identifying the watermarked bag;
retrieving information that associates the watermarked bag with the one or more pieces of produce; and
calculating the sale price from the retrieved information.

10. The method of claim 9, wherein the one or more pieces of produce comprise at least two pieces of produce, and wherein the two pieces of produce are of different types.

11. The method of claim 9, wherein the watermarked bag has a unique identifying code.

12. The method of claim 11, wherein the unique identifying code is a barcode.

13. The method of claim 9, wherein the merchandise identification device is a camera with machine vision.

14. The method of claim 9, wherein the merchandise identification device is a produce identification scanner.

15. The method of claim 9, wherein the merchandise identification device is a barcode scanner and wherein the one or more pieces of produce comprise barcode labels.

16. The method of claim 9, wherein the information associating the watermarked bag with the one or more pieces of produce specifies a quantity and one or more types of produce contained in the watermarked bag.

17. A system for tracking produce in a retail environment, comprising:
one or more bags printed with unique watermarked codes;
a machine vision tracking camera for identifying one or more units of produce being placed into the one or more bags;
a first watermark scanner located proximate to the machine vision tracking camera and the one or more bags for scanning and identifying the unique watermarked codes of the one or more bags containing the one or more units of produce;
a first computing device for receiving produce identifying information from the machine vision tracking camera, receiving bag identifying information from the first watermark scanner, and associating the produce identifying information with the bag identifying information based on the one or more units of produce placed into the one or more bags;
a second watermark scanner located proximate to a point of sale for scanning and identifying the unique watermarked codes of the one or more bags containing the one or more units of produce; and
a second computing device for receiving the bag identifying information from the second watermark scanner, receiving the produce identifying information from the first computing device, and submitting the produce identifying information associated with the bag identifying information to a point of sale device, wherein the point of sale device calculates an amount due.

18. The system of claim 17, wherein the one or more units of produce comprise at least one unit of produce of a first type and one unit of produce of a second type.

19. The system of claim 17, wherein the one or more units of produce are stored in a plurality of bins according to a type and the bins are located within viewing range of the machine vision tracking camera.

20. The system of claim 17, wherein the identifying information received from the first computing device describes a number and one or more types of units of produce contained within one or more bags.

21. A computerized method of tracking unpackaged merchandise for purchase, comprising:
receiving, at a server, merchandise identifying information from one or more merchandise identification devices monitoring a merchandise selection area;
receiving, at the server, bag identifying information from a first watermark scanner in the merchandise selection area;
associating the merchandise identifying information with the bag identifying information at the server;
receiving bag identifying information from a second watermark scanner at a checkout area, wherein the bag identifying information received from the first watermark scanner is the same as the bag identifying information received from the second watermark scanner;
sending the merchandise identifying information associated with the bag identifying information to a point of sale machine at the checkout area upon receiving the bag identifying information from the second watermark scanner.

22. The computerized method of claim 21, wherein the one or more merchandise identification devices are cameras employing machine vision technology.

23. The computerized method of claim 21, wherein the first watermark scanner and the second watermark scanner read a unique watermark code printed on each of one or more bags.

24. The computerized method of claim 21, wherein the point of sale machine utilizes the merchandise identifying information to calculate an amount due.

25. The computerized method of claim 21, wherein the merchandise identification devices are barcode scanners and wherein the one or more units of unpackaged merchandise comprise barcode labels.

26. The computerized method of claim 21, wherein merchandise identifying information comprises the number of and type of unpackaged merchandise selected by a customer in the merchandise selection area.

27. The computerized method of claim 21, wherein bag identifying information identifies a particular bag based on a unique watermark printed on the bag, wherein the bag is selected by a customer in the merchandise selection area.

28. The computerized method of claim 21, wherein the merchandise identification devices are produce identification scanners.
